(19) United States
(12) Patent Application Publication
(10) Pub. No.: US 2009/0137408 A1
(43) Pub. Date: May 28, 2009

(54) Methods, systems, and apparatus for facilitating the design of molecular constructs

(75) Inventor: Joseph M. Jacobson, Newton, MA (US)

Correspondence Address: WOLF GREENFIELD & SACKS, P.C., 600 ATLANTIC AVENUE, BOSTON, MA, 02210-2206, US

(73) Assignee: Codon Devices, Inc., Cambridge, MA (US)

(21) Appl. No.: 12/220,689

(22) Filed: Jul. 24, 2008

Related U.S. Application Data
(63) Continuation of application No. PCT/US2007/001888, filed on Jan. 24, 2007.
(60) Provisional application No. 60/761,684, filed on Jan. 24, 2006.
(60) Provisional application No. 60/761,516, filed on Jan. 24, 2006.

(51) Int. Cl. C40B 30/02; C40B 60/12

(52) U.S. Cl. 506/8; 506/39

(57) ABSTRACT

A system and method for aiding in the design of molecular constructs is provided. A feature set associated with a molecular building block in a construct may be determined, wherein the feature set may comprise data indicative of third party rights that restrict use of the molecular segment or the lack of such rights. The method may include steps of defining a molecular structure for use in the construct; searching a database including a plurality of molecular structures and a plurality of rights, each right of the plurality of rights associated with each of the plurality of molecular structures; and displaying rights associated with the defined molecular structures in response to the search of said database. The system may include a library aggregating a plurality of intellectual property rights relating to fabricating biological constructs; a licensing module licensing the intellectual property rights required to make the specific construct for a fee; an accounts receivable module receiving the fee from a potential maker of the specific construct; and an accounts payable module distributing remuneration to the holders of the intellectual property rights required to make the specific construct.

### CROSS-REFERENCE TO RELATED APPLICATIONS

This application claims the benefit of application Ser. No. 60/761,516, entitled A METHOD AND APPARATUS FOR DETERMINING THE AVAILABILITY OF MOLECULAR SEQUENCES FOR USE IN MOLECULAR CONSTRUCTS, filed Jan. 24, 2006, and application Ser. No. 60/761,684, entitled A METHOD AND APPARATUS FOR THE DESIGN AND FABRICATION OF MOLECULAR CONSTRUCTS, filed Jan. 24, 2006, both of which are incorporated herein by reference in their entireties.

### FIELD OF THE INVENTION

The invention relates generally to the field of synthetic biology and, and more particularly to the field of computer aided design of molecular constructs.

### BACKGROUND OF THE INVENTION

The new science of synthetic biology is predicated on the assumption that biological entities (e.g., genes, proteins and organisms) may be artificially constructed by specifying a molecular sequence and assembling a construct (e.g., a polynucleotide) on the basis of this sequence. For example, a polynucleotide is typically constructed by fabricating shorter segments of nucleotide bases or oligonucleotides and joining those segments together. Once the polynucleotide, such as, for example, a gene, is constructed, the polynucleotide may be incorporated into a vector and used to transfect a given cell line.

The underlying premise is that if a nucleotide sequence is specified, it may be constructed from shorter segments freely. However, nucleotide sequences may be protected in various ways. For example, certain oligonucleotides may be patented and not available for licensing. Thus, simply specifying a nucleotide sequence may be not sufficient if the underlying components are legally unavailable for use.

Further, many molecular segments have dangerous properties, require special handling or have other features (or use restrictions) that make them hard to use. Certain polynucleotides may be better used when introduced into certain vectors or cell types, and some materials may be unsuitable for use in products destined for certain members of the population.

### SUMMARY OF THE INVENTION

Aspects of the invention provide methods and systems for evaluating, designing, assembling, testing, and/or licensing constructs that may be used for biological applications. In some embodiments, constructs may be polynucleotide polymers. In certain embodiments, constructs may be polypeptide polymers. Aspects of the invention relate to analyzing one or more segments of a construct and identifying whether any use restrictions based on one or more rights restrictions (e.g., rights restrictions such as legal, business, and/or other rights restrictions) and/or one or more other features (e.g., structural, functional, and/or other properties) that may form the basis of a design, assembly, application, or other restriction are associated with the segment(s). Restrictions and/or features that are identified may provide information for design, assembly, application, and/or business decisions relating to the construct. One or more aspects of the invention may be computer-implemented, for example, so that a user can access an automated or partially automated system for analyzing a construct to provide information and/or decisions relating to one or more design, development, manufacturing, and/or other business options that may be helpful to the user. A system of the invention may include a data repository comprising use restriction and/or feature information associated with one or more molecular segments (e.g., polynucleotide or polypeptide segments) that can be used as building blocks for larger constructs. A data repository also may include other technical, legal, and/or business information relating to in vitro and/or in vivo applications for constructs and/or construct segments of interest. For example, information relating to therapeutic, agricultural, industrial, research, and/or environmental applications may be provided. Such information may relate to cell lines, organisms, biological assays, chemical assays, packaging, therapeutic compositions, production details, metabolic pathways, etc., or any combination thereof. In some embodiments, rights restrictions related to fabricating a construct (e.g., relating to the chemical synthesis, in vitro amplification, assembly, expression, cloning, etc., of one or more oligo- or poly-nucleotides or peptides) may be provided in a system or data repository of the invention.

Applicants have appreciated that in addition to the biological constraints imposed by the scientific problem being solved, there may be many other considerations that may impact the ability of a bioengineer to make a desired construct. After laboring on the design of the construct, the bioengineer is left to the difficult task of ascertaining what, if any, restrictions exist on the use of each of the proposed molecular segments in the construct. Further, the bioengineer must determine what other considerations will arise in connection with each of the proposed molecular segments and what precautions might be required. Typically, the bioengineer must find the information that he or she needs by hand, accessing many different and unrelated sources. If the bioengineer discovers that one or more proposed molecular segments are not suitable for use in the designed construct, the bioengineer must search for an alternative or replacement molecular segment. The process for “clearing” a molecular segment for use in a construct is not only labor-intensive, but also inefficient, time-consuming, and prone to errors and oversights.

Applicants have further appreciated that biology is characterized by significant intellectual property barriers. In the cases in which biological intellectual property is cross-licensed, it is in an ad hoc manner, requiring fresh negotiations for each piece of intellectual property to be licensed.

Aspects of the invention provide an organized system for analyzing and “clearing” construct segments and final constructs that a user intends to assemble. For example, some embodiments of the present invention provide an efficient marketplace for biological intellectual property rights.

Other embodiments of the invention relate to a method and system for providing information about constructs that are useful for biological applications, and/or about the building blocks that can be assembled to form the constructs. It should be appreciated that constructs or building blocks may be naturally-occurring or synthetic. Further, synthetic constructs may be designed and/or engineered to have naturally-occurring properties (e.g., naturally occurring polynucleotide or polypeptide sequences) once they are fabricated. However, synthetic constructs also may be designed and/or engineered to have non-naturally occurring characteristics (e.g., non-naturally occurring sequence variants, or non-natural combinations of functional elements). It also should be appreciated that the terms constructs and building blocks are relative terms. For example, in the context of a polynucleotide or polypeptide polymer, a building block may be a shorter segment of the polynucleotide or polypeptide polymer. However, the polynucleotide or polypeptide polymer itself may be used as a building block for a larger polynucleotide or polypeptide polymer. Embodiments of the invention provide a method and system for determining use restrictions and/or other features associated with constructs and/or smaller building blocks (e.g., molecular segments) that each can be used alone or in suitable combination to assemble multicomponent biological and/or synthetic devices and systems. Further, embodiments of the invention provide a method and system for identifying constructs and/or smaller building blocks having a defined feature set as candidates for a predetermined application specified by a user (e.g., for use in a predetermined biological system, for example, a recombinant cell).

Accordingly, aspects of the invention relate to a system and method for aiding in the fabrication of biological constructs. In one aspect the system includes a library aggregating a plurality of intellectual property rights relating to fabricating biological constructs; a licensing module licensing the intellectual property rights required to make the specific construct for a fee; and an accounts receivable module receiving the fee from a potential maker of the specific construct. In one embodiment, the system includes an accounts payable module distributing remuneration to the holders of the intellectual property rights required to make the specific construct. In another embodiment the system further includes a design module defining the steps of the process and the materials by which the specific construct is to be fabricated. In still another embodiment the system further includes a fabrication module utilizing the defined steps of the process and the materials by which the specific construct is to be fabricated in order to fabricate the specific construct.

In yet another embodiment, the system further includes a testing module for testing the fabricated specific construct against a predetermined criterion. The design module is utilized to re-define the steps of the process and the materials by which the specific construct is to be fabricated if the fabricated specific construct does not meet the predetermined criterion. In still yet another embodiment the library of aggregated intellectual property rights are aggregated from a plurality of intellectual property rights holders. In another embodiment, the design module is a computer aided design (CAD) module. In yet another embodiment, the library aggregating a plurality of intellectual property rights relating to fabricating biological constructs; the licensing module licensing the intellectual property rights required to make the specific construct for a fee; the accounts receivable module receiving said fee from a potential maker of the specific construct; the accounts payable module distributing remuneration to the holders of the intellectual property rights required to make the specific construct; the design module defining the steps of the process and the materials by which the specific construct is to be fabricated; and the fabrication module utilizing the defined steps of the process and the materials by which the specific construct is to be fabricated in order to fabricate the specific construct are controlled by a single entity.

In another aspect, the invention relates to a method for aiding in the fabrication of a specific biological construct. In one embodiment, the method includes the steps of aggregating a plurality of intellectual property rights relating to fabricating biological constructs; licensing the intellectual property rights required to make the specific construct for a fee; and receiving said fee from the potential maker of the specific construct. In one embodiment, the method includes distributing remuneration to the holders of the intellectual property rights required to make the specific construct. In another embodiment, the method includes the steps of defining the steps of the process and the materials by which the specific construct is to be fabricated. In another embodiment, the method further includes the steps of utilizing the defined steps of the process and the materials by which the specific construct is to be fabricated in order to fabricate the specific construct. In still yet another embodiment, the method includes the steps of testing the fabricated specific construct against a predetermined criterion; and re-defining the steps of the process and the materials by which the specific construct is to be fabricated if the fabricated specific construct does not meet the predetermined criterion. In still yet another embodiment, the defining of the steps of the process and the materials by which the specific construct is to be fabricated is performed with a computer aided design system. In another embodiment, the library of aggregated intellectual property rights are aggregated from a plurality of intellectual property rights holders. In one embodiment, the steps of licensing the intellectual property rights required to make the specific construct for a fee and the receiving of said fee from the potential maker of the specific construct is performed once for the specific construct. In another embodiment, the method includes the step of collaboratively marketing said specific construct. In still yet another embodiment, the method includes the step of collaboratively marketing a therapeutic or a diagnostic product identified using the specific construct. In a further embodiment, the method further includes the steps of identifying a therapeutic or diagnostic product using the specific construct; and collaboratively marketing the therapeutic or a diagnostic product.

Another aspect of the invention also relates to a clearinghouse which comprises a source of information about biological parts for the construction of synthetic biological constructs. More particularly, one embodiment of the invention provides a system for determining legal rights and/or other features associated with defined biological building blocks that can be used in combination to assemble many-component biological devices and systems. In addition, some embodiments of the invention provide a system for identifying biological parts or building blocks that have a defined feature set as candidates for use in a construct.

One embodiment of the invention provides methods and devices useful in computer aided design of a construct. According to this embodiment, a method for computer aided design of a multimeric construct comprises defining a feature set of biological parts, such as molecular DNA segments, that is suitable for use in the construct. Such a feature set includes public, private, or contractual use restrictions (or notation of lack thereof) on biological parts, such as patent restrictions, transfer restrictions, commercialization restrictions, safety restrictions, governmentally imposed restrictions, and field of use restrictions. By way of example, the data may provide notification that: use of a part requires a license, and may specify license terms in various contexts; the part must be used in a facility having some special level of biological containment; use of the part in combination with some other class of parts may constitute patent infringement; etc. The feature set may and typically will also include one or more characteristics, properties, values or attributes of the parts. For example, a feature set may comprise a characteristic related to function, utility, source (e.g., species, experimental system, etc.), cell-type specific and/or species-specific properties (e.g., expression, stability, toxicity, susceptibility to cell-type or species specific nucleases or proteases, etc.), interoperability with other parts or segments, nucleic acid sequence, amino acid sequence, codon usage, molecular weight, tertiary structure, quaternary structure, mRNA secondary structure, post-translational modifications, reactivity, modification sites, modes of detection, polarity, solubility properties such as hydrophobicity/hydrophilicity, membrane permeability, stability, bioavailability, safety, toxicity, isoelectric point, charge, thermostability, melting temperature, annealing temperature, catalytic activity, side groups, topology, kinetic complexity, immunogenicity, environmental hazards, and any combination of any of the foregoing, or other features. One or more of the characteristics of the feature sets described herein may provide a use restriction at any stage (e.g., design, assembly, application, testing, etc.) relating to the constructs described herein. For example, one or more of the features may form the basis of a determination that a construct has one or more undesirable properties. For example, in some embodiments, a user may specify a specific threshold level for each of one or more features or characteristics described herein (e.g., structural and/or functional properties), above which constructs are identified as being undesirable. In certain embodiments, a user may specify a specific threshold level for each of one or more features or characteristics described herein (e.g., structural and/or functional properties), below which constructs are identified as being undesirable. It should be appreciated that a system of the invention may provide feature information for construct building blocks taken alone and/or for combinations of two or more construct building blocks.

In some embodiments, a system of the invention may include a macro or routine (e.g., any suitable computer code) that can be accessed by a user to design a construct (e.g., a sequence) for expression in one or more user-specified cell type or species (e.g., from a list of available cell types or species provided by the system). In some embodiments, the macro or routine may be used to convert sequences (e.g., nucleic acid and/or protein sequence) of a designed construct or set of constructs to be optimized for replication and/or expression in one or more selected cell types and/or species. In some embodiments, different restrictions (e.g., rights restrictions, restrictions based on structural, functional, and/or other characteristics described herein, or any combination thereof) may be identified from the data repository for different cells types and/or species. Accordingly, a designer may use a system of the invention to determine which species and/or cell types to use in connection with one or more constructs of interest. In some embodiments, a user may use aspects of the invention to determine which species and/or cell types one or more constructs should be designed and/or fabricated for (e.g., based on patent rights, other use restrictions, expression properties, structural properties, functional properties, toxicity, etc., or any combination thereof in different cell types and/or species).

In one embodiment, the method further comprises searching a database, and/or collection of public and/or private databases, that comprises a plurality of molecular segment building blocks and a plurality of features. Each of the molecular segments may be associated with at least one feature. According to one aspect of the invention, the method comprises determining from the database a molecular segment that is suitable for use in the construct as one having the defined feature set.

According to another embodiment of the invention, a first molecular segment building block, or combination of building blocks, is defined, and a database is searched. The database may comprise a plurality of molecular segments and a plurality of features, each of the plurality of molecular segments being associated with at least one feature. In one embodiment, a first feature set that is associated with the first molecular segment is determined. Optionally, in another embodiment, a second molecular segment building block, or combination or building blocks, having a second feature set that is an alternative to the first feature set is determined as an alternative molecular segment for use in the construct. According to one aspect of the invention, molecular segment building blocks may comprise one or more nucleobases, natural nucleotides, unnatural nucleotides, nucleotide analogs, modified nucleotides, codons, nucleic acids, oligonucleotides, polynucleotides, natural amino acids, unnatural amino acids, amino acid analogs, modified amino acids, peptides, polypeptides, chemical moieties, small molecules, vectors, plasmids, restriction sites, primers, hybridization sites, selection markers, detection markers, linkers, labels, ligands, antigens, and antibodies or fragment thereof. Generally, aspects of the invention can be applied to building a gene or a protein from subparts such as oligonucleotides or oligopeptides, a transcription unit (an open reading frame plus regulatory elements), assemblies of multiple genes, vectors, chromosomes, genomes, and cells, all from smaller bioparts. In another embodiment, building blocks may comprise a combination of any one or more of the foregoing. For example, in an oligonucleotide construct, a nucleotide analog linked to a detection marker may be considered to be a single molecular segment, or may be considered to two or three molecular segments (i.e., the detection marker, the nucleotide analog, and the chemical linker). As other examples, the biopart may be a 50 Kb DNA polynucleotide encoding and controlling expression of a group of enzymes that catalyze formation of an organic molecule, or may be a cell for addition to a culture which has a complementary function, e.g., secretes a nutrient necessary for survival of other cells in the culture. Accordingly, nucleic acid or polypeptide building blocks may be polymers each having about 4 to 10; about 10 to 50; about 50 to 100; about 100 to 1,000; about 1,000 to 10,000, or fewer or more nucleotide or amino acid monomers, respectively.

Another aspect of the invention relates to a method for determining the rights associated with the use of molecular segment building blocks in a construct. In one embodiment, the method includes the steps of: defining a molecular segment for use in the construct; and searching a database for rights associated with the defined molecular segment. In this embodiment, the database includes a plurality of molecular segments and a plurality of rights, each right of the plurality of rights associated with at least one of the plurality of molecular segments. In another embodiment, the method further comprises the step of displaying the rights associated with the molecular segment. In yet another embodiment, the construct includes a polynucleotide and the molecular segment comprises an oligonucleotide or smaller polynucleotide, e.g., an open reading frame or portion thereof, or a regulatory segment. According to another embodiment, the method further includes the step of decomposing the construct into a plurality of building blocks. In another embodiment, the method further includes the step of identifying an alternate building block if the rights associated with the defined building block do not reach a predetermined specification. In yet another embodiment, the rights in the database are selected from a group consisting of patent restrictions, transfer restrictions, commercialization restrictions, safety restrictions, governmentally imposed restrictions, and field of use restrictions. Another aspect of the invention provides a system for determining the rights associated with the use of molecular segments in a construct. In one embodiment, the system includes a molecular segment module defining a molecular segment for use in the construct; a database including a plurality of molecular segments and a plurality of rights, each right of the plurality of rights associated with at least one of the plurality of molecular segments; a database manager for searching the database for the defined molecular segment and a display displaying rights associated with the defined molecular segment in response to the search of the database. In one embodiment, the construct includes a polynucleotide and said molecular segment comprises an oligonucleotide or smaller polynucleotide, e.g., an open reading frame or portion thereof, or a regulatory segment, or any other selected polynucleotide segment.

In one embodiment, the system further includes a construct decomposer for decomposing a construct into a plurality of molecular segments (e.g., 2, 3, 4, 5, about 5 to 10, about 10 to 20, about 20 to 50, about 50 to 100, or more different molecular segments). In yet another embodiment, the system further includes an alternative molecular segment identifier for identifying an alternate molecular segment if the rights associated with the defined molecular segment are incompatible with one or more other segments in the construct, fail to meet some criteria, or do not reach a predetermined level. The predetermined level may be, for example, no associated rights, so the molecular segment is freely available for use, or third party ownership but available for use under a license agreement. In yet another embodiment, the rights in the database are selected from a group consisting of patent restrictions, transfer restrictions, commercialization restrictions, safety restrictions, governmentally imposed restrictions, and field of use restrictions.

In another aspect, the invention relates to a database including a first plurality of records, each of said first plurality of records corresponding to a respective one of a plurality of molecular structures; and a second plurality of records, each of said second plurality of records corresponding to a respective one of a plurality of rights, wherein each of the plurality of first records is associated with at least one of the plurality of second records. In one embodiment, a database includes a compilation comprising information, documents, records and/or files, while in another embodiment, a database comprises electronic links or hyperlinks to information, documents, records, and/or files.

In a further embodiment, the invention provides a method for obtaining a right to use a building block such as a molecular segment in a construct comprising defining a molecular segment for use in a construct and searching a database. The database comprises a plurality of molecular segments and an associated plurality of use restrictions. Each of the plurality of use restrictions is associated with at least one part or molecular segment. In one embodiment, the database also includes at least one form license to use a part or molecular segment associated with a use restriction. According to one aspect of the invention, the method further comprises identifying a use restriction associated with the defined part or molecular segment. In one embodiment, optionally, a form license to use the defined part or molecular segment is accessed and, if desired, made available for inspection and execution.

In another embodiment, the database may comprise annotations in addition to rights and specifications associated with a part or molecular segment, such as literature references, attributions, publications, patent references, purchasing information, and/or ordering capabilities. Embodiments of the invention provide a functionality to access an on-line or otherwise remotely accessible repository/collection of extensively annotated biological parts offered for sale by a proprietor. In this respect, the U.S. application Ser. No. 09/996,649, METHODS AND SYSTEMS FOR DESIGNING MACHINES INCLUDING BIOLOGICALLY-DERIVED PARTS, (WO/02/1034661), which is incorporated herein by reference, can be referred to.

It is contemplated that diverse researchers could choose to deposit voluntarily their biological discoveries and creations, or the sequence information defining them, with the repository, which would act as a distributor to interested researchers and scientists. The researchers could specify the structure, sequence, use restrictions, royalty loads, compatibility data, functional data, etc. of his or her created or discovered biological part. Accordingly, a system or data repository of the invention also may enable a user to submit information (e.g., relating to restrictions, structural properties, functional properties, etc.) that the user determined based on the assembly, analysis, and/or use of one or more constructs and/or construct building blocks alone or in combination with one or more additional constructs and/or construct building blocks. This information may be monitored, checked, and/or annotated by a system administrator. The information may include any type or information including, for example, technical data. For example, the information may include one or more descriptions and/or data sets relating to the interaction of one or more different constructs or building blocks (e.g., molecular segments—for example, different functional and/or structural domains or motifs) under different conditions, when combined with other constructs or building blocks (e.g., molecular segments), when cloned into certain vectors, when expressed in certain cells, when expressed in a host cell in the presence of one or more genomic mutations, when expressed or replicated in a host cell in the presence of one or more other constructs and/or building blocks (e.g., molecular segments), etc., or any combination thereof. The information may include one or more links to a remote site (e.g., a public database) where information may be stored. Accordingly, the content of a system and/or data repository of the invention may be enhanced as additional information is provided by users.

In some aspects of the invention, a repository may be complemented by a clearinghouse function, and optionally might manufacture polynucleotides, proteins, or cells for its inventory and/or to the specifications of a customer. The repository/clearinghouse may also provide on-line bioconstruct design aids, access to simulation software for virtual testing of constructs, and information regarding downstream use of bioparts.

It should be understood that the embodiments above-mentioned and discussed below are not, unless context indicates otherwise, intended to be mutually exclusive.

### BRIEF DESCRIPTION OF THE DRAWINGS

The foregoing and other objects, aspects, features, and advantages of the invention will become more apparent and may be better understood by referring to the following description taken in conjunction with the accompanying drawings, in which:

FIG. 1 is a schematic block diagram illustrating a system according to embodiments of the invention;

FIG. 2 is a schematic diagram illustrating an exemplary computing environment on which embodiments of the invention can be implemented;

FIG. 3 is a schematic diagram illustrating an example of data structures used in the design phase and rights management phase modules of FIG. 1 in accordance with one embodiment;

FIG. 4 is a schematic diagram illustrating a construct decomposing capability according to embodiments of the invention; and

FIG. 5 is a flowchart illustrating a method for design of constructs according to embodiments of the invention.

### DETAILED DESCRIPTION

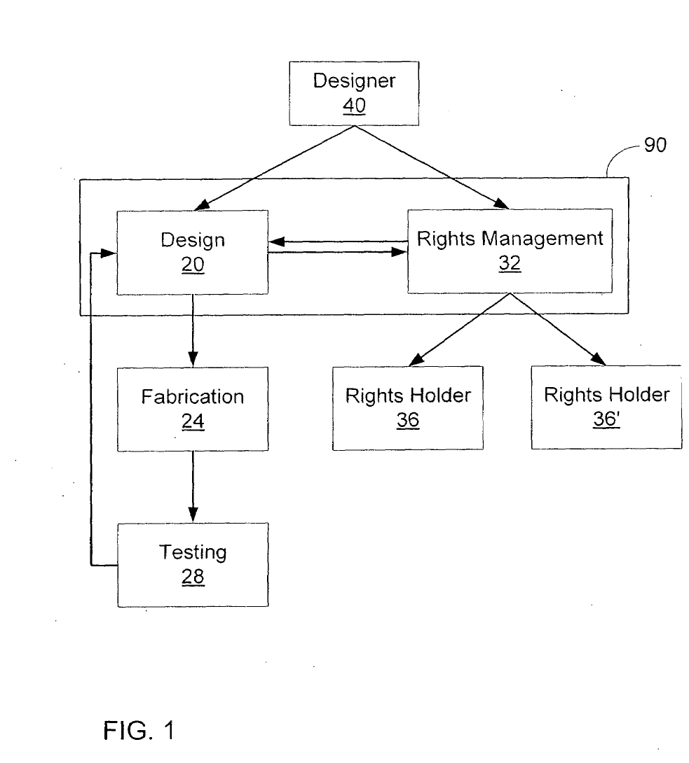

Aspects of the invention relate to methods and systems for analyzing, designing, assembling, testing, and/or licensing molecular constructs that can be used in biological systems. Embodiments of the invention provide a system for designing, constructing and/or testing molecular constructs. FIG. 1 illustrates such a system which includes a design phase module 20, a fabrication phase module 24, a testing phase module 28, and a rights management module 32.

It should be appreciated that the term “construct” as used herein may include one or more structures along the entirety of the cascade of biological complexity, whether produced naturally or synthetically. Thus, for example, a construct may be an open reading frame or other DNA encoding or controlling expression of domains of a synthetic or naturally occurring protein, or plural DNAs which act cooperatively to achieve some goal, such as implementing a series of enzymatic changes in a substrate, defining a timing circuit in a cell, defining the parts of an expression vector, adapting a cell for use as a sensor of some xenobiotic in waste water, or implementing nanostructure designs. Alternatively the construct may be a protein having a specified set of properties, in which case the design may involve assembly at the DNA level (i.e., design of a precursor to the desired construct), expression and testing of a plurality of combinations of protein domains, and construction of various different candidate proteins by assembly of different genetic elements encoding the domains. In some embodiments, a construct may be an RNA molecule. In other embodiments, a bioconstruct may be a cell engineered to have some specific set of properties, or a collection of different cells that cooperate to achieve some function. In some embodiments, constructs may be molecular constructs comprising polynucleotide polymers. In other embodiments, constructs may be molecular constructs comprising polypeptide polymers. Accordingly, it should be appreciated that a construct may be divided into, or assembled from, smaller molecular segments (e.g., shorter poly- or oligo-nucleotides or shorter poly- or oligo-peptides) that may be referred to as building blocks in some embodiments of the invention. It also should be appreciated that a construct assembled using one or more methods or systems of the invention may be used as a building block for a larger construct or a biological system (e.g., a larger engineered polypeptide, a larger engineered nucleic acid, a recombinant vector, a recombinant cell, etc.).

In embodiments of the invention, molecular segment building blocks also may include one or more structures along the entirety of the cascade of biological complexity, whether produced naturally or synthetically. Accordingly, molecular segment building blocks may comprise one or more nucleobases, natural nucleotides, unnatural nucleotides, nucleotide analogs, modified nucleotides, codons, nucleic acids, oligonucleotides, polynucleotides, natural amino acids, unnatural amino acids, amino acid analogs, modified amino acids, peptides, polypeptides, chemical moieties, small molecules, vectors, plasmids, restriction sites, primers, hybridization sites, selection markers, detection markers, linkers, labels, ligands, antigens, antibodies or fragment thereof, or any combination thereof. The constructs may be assemblies of multiple genes incorporated into vectors, chromosomes, genomes, and cells.

Embodiments of the invention will be described, by way of example only and not intending to limit the scope of the invention, as applied to building a gene or a protein from smaller building blocks such as, for example, nucleotides, oligonucleotides, polynucleotides, a transcription unit (an open reading frame plus regulatory elements), amino acids, peptides, polypeptides, or any other suitable building blocks.

In some embodiments, the design phase module 20 includes information on building blocks and processes that may be used to create a molecular construct of interest. The design phase module 20 may produce a design specification of one or more constructs according to certain design requirements provided by a designer in any suitable manner. It should be appreciated that in some embodiments, a designer may choose to fabricate a single construct. However, a system of the invention may be used to design, assemble, test, and/or license a library of constructs. In some embodiments, a designer may specify or enter design information in the form of one or more sequences (e.g., nucleic acid and/or polypeptide sequences) to be analyzed, fabricated, and/or tested. The design module may analyze and/or decompose this sequence information to identify sequence segments that may be evaluated (e.g., screened) independently or in combination against the data repository. However, in some embodiments, the design module may evaluate (e.g., screen) the entire sequence directly against information in the data repository without involving an act of decomposing the sequence information or identify sequence segments. In certain embodiments, a designer may specify or enter one or more structural properties, functional properties, species specific properties, any other suitable properties, and/or any combinations thereof that are desired (e.g., 2, 3, 4, 5, about 5 to 10, about 10 to 20, about 20 to 50, about 50 to 100, or more different properties or combinations thereof). The design phase module 20 may include information on components and processes that may be used to create one or more molecular construct(s) of interest. The design phase module may identify one or more molecular segments that provide these different properties and design one or more different constructs that satisfy the design criteria. In some embodiments, a plurality (e.g., 1, 2, 3, 4, 5, about 5 to 10; about 10 to 100; about 100 to 1,000; about 1,000-10,000; about 10,000 to 100,000; or more) different constructs may be provided by the design phase module that all satisfy the design criteria. In some embodiments, a user may specify how many different constructs are wanted. In some embodiments, the different constructs may be related (e.g., have related nucleic acid sequences, amino acid sequences, structural properties, functional properties, or any combination of two or more thereof). It should be appreciated that the nature of the design criteria may impact the number of possible different constructs that satisfy the design criteria (e.g., depending on whether specific sequences are provided and/or whether specific or general structural and/or functional properties of interest are provided). If a plurality of different constructs satisfy the design criteria, all or a subset of them may be fabricated and/or tested to determine whether one or more of them is preferred based on any suitable criteria (e.g., assembly, function, expression levels, etc.). The fabrication phase module 24 may be a laboratory (e.g., molecular, chemical or any other suitable) which is capable of building the molecular construct according to the specification created by the design phase module 20. The testing phase module 28 may be a testing laboratory (e.g., molecular, chemical or any other suitable) which is capable of testing the molecular construct fabricated by the fabrication phase module 24 to determine if the construct meets the design requirements.

The rights management module 32 may comprise a data repository that includes information identifying use restrictions on a plurality of construct building blocks that a designer may include in a design for a construct or a product produced by a succession of steps involving the construct and/or construct building blocks. The use restrictions may be legal rights (e.g., intellectual property rights (IPR)), or any other rights restricting the use of the construct and/or its building blocks imposed by various rights holders or other agents. For example, the use restrictions may be patent restrictions, transfer restrictions, commercialization restrictions, safety restrictions, governmentally imposed restrictions, field of use restrictions, and any other restrictions. The use restrictions may (optionally) also provide a notification that a construct building block must be used in a facility providing some special conditions, that use of the construct building block in combination with some other class of construct building blocks may constitute patent infringement, or any other suitable notice that may be helpful to designer.

In one embodiment, the rights management module 32 may also manage the licensing of rights and payment of licensing fees to the rights holders 36 and 36′ by the designer 40. It should be appreciated that any other agent may act on behalf of the designer 40 to negotiate license use and payment of licensing fees with the rights holders 36 and 36′. The rights management module 32 may include an accounts payable module distributing remuneration to the holders of the intellectual property rights (not shown). It should be appreciated that the rights management module 32 need not manage the licensing of rights in all embodiments.

It should be appreciated that in some embodiments, a system of the invention may include a restriction management module that includes information identifying any features (e.g., structural and/or functional properties and/or any other feature set characteristics described herein) that may be used to restrict the constructs or construct building blocks that are selected for assembly or use. In some embodiments, a user may determine threshold levels of these features that may be used to restrict the selection of constructs and/or construct building blocks that are used and/or assembled. Any feature described herein may be used, alone or in combination with one or more other features, as a basis restrict the selection of one or more constructs or construct building blocks. In some embodiments, a user may determine which feature(s) are used and which threshold levels are used as a basis for a design restriction. Accordingly, a restriction management module may be based on features other than rights restrictions. However, a restriction management module also may include rights restrictions. It should be appreciated that one or more restrictions on the constructs and/or construct building blocks (e.g., molecular segments) may be imposed on a method or system of the invention to limit the number of different constructs that satisfy certain initial design criteria.

Once the data repository of the system is populated, the system holder in one embodiment may act as a broker and not only inform the users of available licenses and their terms, but also act as an intermediary to obtain the requisite licenses for the user. For example, in one embodiment discussed below, the data repository may also include a license to any molecular segment that is associated with the use restriction.

Embodiments of the invention may provide a capability to facilitate payments of intellectual property royalties for a designed construct. For example, the intellectual property royalties for a designed construct may be predicated on the number of cells utilizing the intellectual property protecting the construct. In one embodiment, enforcement of royalty payments may be accomplished, for example, by allowing the cell to undergo a finite number of cell divisions before the cell dies (e.g., by the insertion of a synthetic biology cell division counter coupled to a cell death mechanism) or by only using cells (e.g., auxotrophic cells) that require proprietary and exhaustible co-factors to live.

The designer 40 may employ the design phase module 20 to design one or more constructs in any suitable manner (e.g., by specifying the construct building blocks and processes required to build the construct). Once the design of the construct is finalized, the rights management module 32 may be used to determine which use restrictions, if any, on the construct and/or its building blocks are contained in the system. In some embodiments, if the use restrictions comprise rights available for licensing, the rights management module 32 may provide a license including the terms required for licensing the rights. The designer can access the license for review or execution. Such a license may be, for example, in a printable format that the designer can print out, sign, and submit to a licensor or intermediary, or the license may be a so-called “click through” license that is agreed to electronically. In one embodiment, the designer 40 has the option of accepting the terms of the license or redesigning the construct. If the designer 40 accepts the terms of the license, the designer 40 may need to make a payment to the rights management module 32 for distribution to one or more of the rights holders 36 and 36′. If the rights required to use (in one form or another) the designed construct are not available for license, the designer 40 may return to the design phase module 20 to design a new construct which may avoid using any building blocks that are unavailable for license, or are not official at desirable licensing terms.

Upon completion of the design phase, the design may be provided (e.g., by the designer or automatically) to the fabrication phase module 24 to fabricate the designed construct(s). The fabrication phase module 24 may be a molecular, chemical or any other suitable laboratory which is capable of fabricating the construct. It should be appreciated that the fabrication phase module 24 may use any suitable resources to fabricate the construct. For example, the fabrication module may employ one or more automated laboratories (e.g., robotic nucleotide or robotic amino-acid polymer manufacturing facilities) or any other suitable facility. In some embodiments, fabrication may involve any suitable combination of chemical synthesis, and/or in vivo, and/or in vitro assembly.

Once the one or more constructs have been fabricated, they may be tested by the testing phase module 28 to determine if they meet the requirements specified by the designer 40. The requirement can be specified and tested in any suitable manner. The testing phase module 28 may be a molecular, chemical or any other suitable testing laboratory which is capable of testing the construct(s). It should be appreciated that the testing phase module 28 may use any suitable resources to test the construct(s). If the testing phase module 28 determines that the construct(s) meets the requirements specified by the designer 40, the work of the designer 40 is completed. If, however, the construct(s) fails to meet the specified requirements, the designer 40 may return to the design phase module 20 to redesign the construct(s) and repeat the process until the construct(s) is designed and successfully tested.

In some embodiments of the invention, one or more of the modules 20, 24, and 28 may be located on a server accessible over the Internet, thereby allowing the designer 40 to remotely access the system from any desired location. In some embodiments, the designer 40, or any other user or an operator of the system, may transmit information on the construct specification or any information to be transferred between modules to remote locations for further processing, fabrication or testing of the construct. The transfer of information may occur between the modules using any appropriate channels, e.g., computer-readable media encoded with the information, over a private or public (e.g., the Internet) network, or otherwise.

It should be appreciated that although one illustrative embodiment is described herein in which a designer uses each of the modules discussed above to design, fabricate and test a construct, it is contemplated that not all the modules need be in the same facility, and that various combinations of the modules may be in different locations. For example, it is contemplated that the design module and rights management module may be used together in one facility, and that the fabrication and testing may take place at locations owned and operated by others. This is merely one example of the various configurations that are possible. In addition, it is contemplated that not all of the modules described above, nor features of each, be employed in all embodiments of the present invention. For example, it is contemplated that the design module and the rights management module may be used together to facilitate a design, but decoupled from any system for performing fabrication and testing. In addition, and as discussed above, it should be appreciated that the aspects of the present invention described herein that relate to procuring a license to any protected subject matter need not be employed in all embodiments of the present invention, as the rights management module 32 can alternatively simply notify the designer of any relevant rights without acting as an intermediary to obtain a license thereunder.

In some embodiments of the invention, the design phase module 20 may include a data repository comprising a library of constructs, construct building blocks, and/or any combination of constructs and construct building blocks. The library may be built in any suitable manner, and, in one embodiment, may be populated by collecting information from different sources. For example, designer 40 may submit a construct, one or more construct building blocks, or a combination of construct building blocks to the library for use by others.

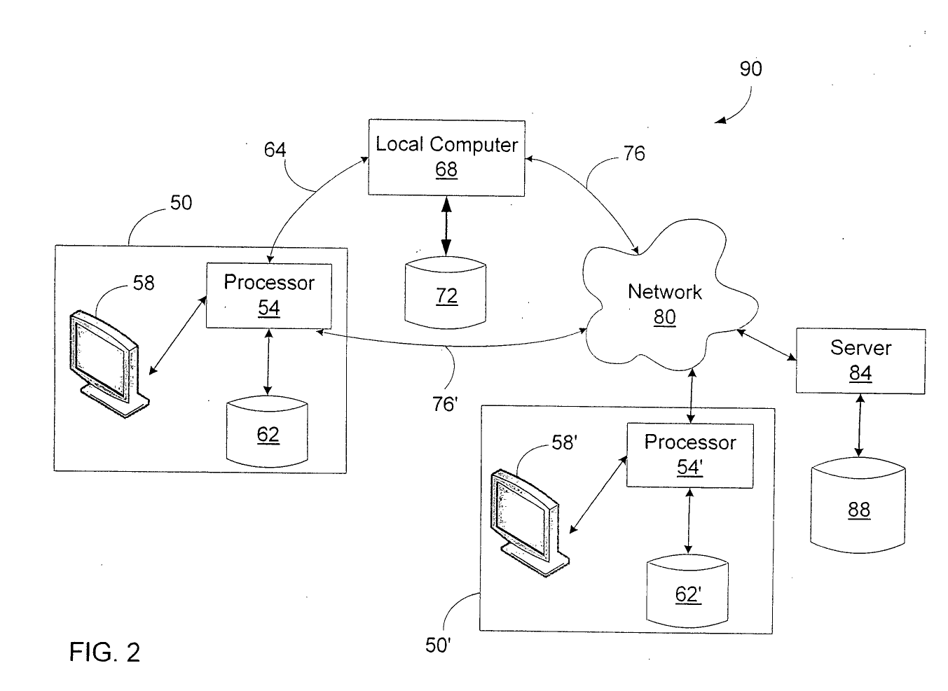

FIG. 2 illustrates an illustrative computing environment 90 on which embodiments of the invention may be implemented. It should be appreciated that the computing environment 90 is disclosed herein merely for illustrative purposes, and that the aspects of the present invention described herein can be implemented on any suitable computing environment, including a stand alone computer, or a distributed computing environment wherein multiple computers can distribute the functionality of the system described herein in any suitable manner and can communicate in any suitable manner (e.g., over a public or private network, or otherwise). The illustrative computing environment 90 includes a workstation 50 having a processor 54, a terminal 58, and a data storage device 62. In some embodiments, the workstation 50 may be a local stand-alone system (e.g., a desktop computer, laptop computer, or palmtop computer) which permits the user to utilize the functionality of the system. The terminal 58 may include any suitable input/output interfaces (e.g., a display, a mouse, a keyboard, a touch screen, a trackball, a digitizing table or any other suitable I/O device). The display may provide a graphical user interface

for the system that, for example, enables the designer to specify at least a portion of a construct, receive feedback relating to use restrictions identified for the at least a portion of the construct, and exchange any of the other information described herein. The data storage device 62 may be any suitable storage device, including but not limited to, storage media such as ROMs, RAMs, floppy disks, CD-ROMs, DVDs, a high volume magnetic or optical disk drive, a distributed storage system implemented in a form of Redundant Arrays of Independent Disks (RAID) system, etc. In embodiments of the invention implemented on a stand-alone system, the same processor 54, terminal 58 and data storage device 62 are used for designing the construct as for managing the use restrictions, including intellectual property rights relating thereto.

In other embodiments, the system may not be implemented on a stand alone computer accessed by the designer. For example, the workstation 50 may be connected (e.g., by a local network 64 or otherwise) to a central local computer 68. Thus, the workstation 50 may act as the front-end to the local computer 68 so that the data storage device 62 on the workstation system 50 may be used to store only local data, e.g., the data input by the user. A data repository comprising the library of constructs, construct building blocks, any combination of constructs and construct building blocks and any of the other information described herein, may be stored at the central local computer 68 in storage device 72 that can be of any suitable type (e.g., a high volume magnetic or optical device or any of the other types described above for storage device 62). In these embodiments, the functions of the design phase module 20 and the rights management module 32 may be implemented by the local computer 68, using the workstation 50 as an input device. Alternatively, the design and rights management functions may be divided in any suitable way among the local computer 68 and the workstation 50.

In other embodiments of the invention, the local computer 68 and/or the workstation 50 may be connected, via connections 76 and 76′, respectively, through a wide area network 80, such as, for example, the Internet, to a server 84. The connections may be via any suitable communication media (e.g., wireless, wired, a combination thereof, etc.). A data storage device 88 (which may be any of the types described above for storage devices 62 and 72) that is coupled to the server 84 supplies data to multiple workstations 50, 50′ on the network 80. The workstation 50′ has a processor 54′ connected to data storage device 62′ and a terminal 58′. Because one or more servers 84 and data storage devices 88 may be processing simultaneously multiple requests from many clients (e.g., workstations 50, 50′) that may be located in different locations, the server 84 may be a high throughput device connected to a large volume high access rate data storage system 88, although the invention is not limited in this respect. The functions of the design phase module 20 and the rights management module 32 can be partitioned among the workstations 50, the local computer 68, and the server 84 in any suitable manner.

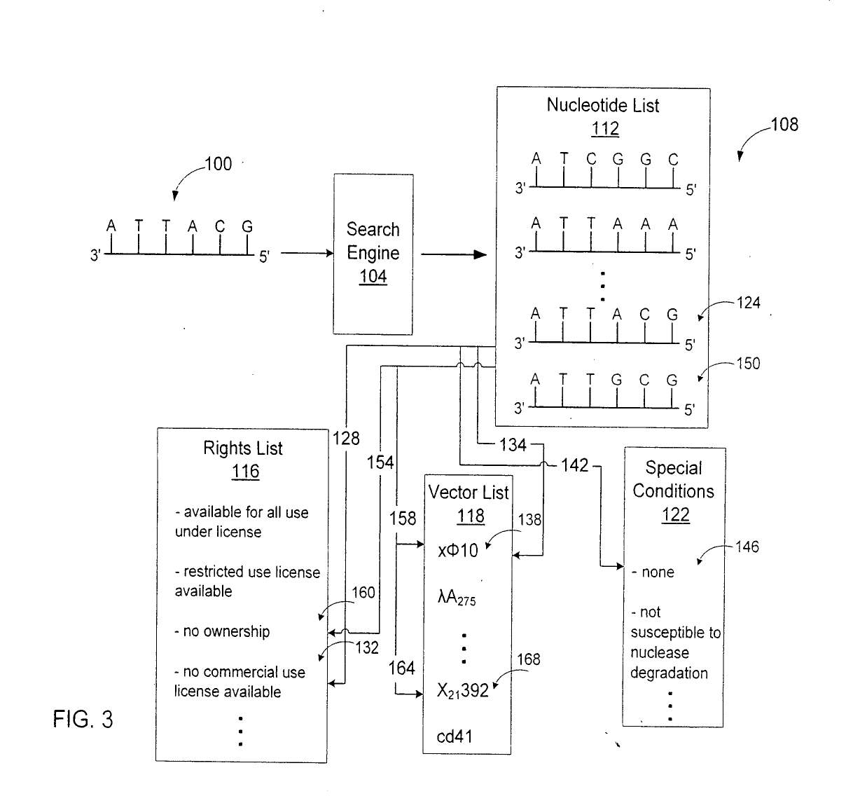

FIG. 3 is a schematic diagram illustrating an example of data structures used in the design phase and rights management phase modules according to some embodiments of the invention. When the designer 40 (e.g., a bioengineer or a scientist) desires to use a molecular segment 100, shown by way of example only as a nucleotide sequence 100, the designer 40 enters the sequence (e.g., using the workstation terminal 58). A database search engine 104 may be located on the processor 54, local computer 68, and/or server 84, depending upon whether the system is located at the workstation 50, local computer 68 or server 84 or distributed among them. The data storage device(s) 62, 72, and 88, associated with the search engine 104, may be queried to find a matching nucleotide sequence in the database 108, according to any suitable criteria. In some embodiments of the invention, the database 108 includes a list 112 of constructs and construct building blocks (e.g., nucleotide sequences shown by way of example in FIG. 3); a list of rights, or use restrictions, 116; and other suitable information, such as, for example, a list of transfection vectors 118 and a list of special information or conditions 122 relating to the molecular segments.

Various bioinformatics, machine learning, statistical learning, pattern recognition and other algorithms may be employed by the database according to embodiments of the invention. For example, the Smith-Waterman dynamic programming algorithm (T. Smith and M. Waterman. Identification of Common Molecular Subsequences. Journal of Molecular Biology, 147:195-197, 1981), heuristic algorithms such as BLAST (S. F. Altschul, W. Gish, W. Miller, E. W. Myers, and D. J. Lipman. Basic local alignment search tool. Journal of Molecular Biology, 215:403-410, 1990) and FASTA (W. R. Pearson. Rapid and sensitive sequence comparison with FASTP and FASTA. Methods in Enzymology, 183:63-98, 1985) may be used to compare a query nucleotide or protein sequence against the database of sequences, and uncover similarities and sequence matches. Furthermore, such machine learning algorithms as, for example, support vector machines (V. N. Vapnik. Statistical Learning Theory. Adaptive and learning systems for signal processing, communication, and control. Wiley, N.Y., 1998), Bayesian networks (J. Pearl. Probabilistic Reasoning in Intelligent Systems. Morgan Kaufmann, 1988), and Hidden Markov Models (L. R. Rabiner. A Tutorial on Hidden Markov Models and Selected Applications in Speech Recognition. Proceedings of the IEEE, 77:257-286, 1989), to name a few, and their more recent developments may be utilized to detect patterns within and among sequences (e.g., nucleotide and amino acids), classify the sequences, and make various predictions about the sequences. Any other suitable algorithms may be also employed.

In the example of FIG. 3, the database 108 is implemented as a linked list of records grouped according to a schema. However, it should be appreciated that the aspects of the present invention described herein are not limited to employing a database that is implemented in any specific manner, nor to even employing a database at all, as any suitably searchable data repository can be employed. In the example shown, the nucleotide segment 100 is found within the nucleotide list 112 in the database 108. In some embodiments of the invention, the found nucleotide sequence 124 (ATTACC) is forwardly and backwardly linked to the other lists 116, 118, and 122 contained in the database 108. The forward and backward linkages permit the user to search in any direction from any individual datum. Thus, the user (e.g., the designer or another) may specify a nucleotide sequence and obtain the rights corresponding to the sequence or specify a defined license and find all the building blocks to which the license applies. It should be appreciated that the specific implementation of the database 108 shown, wherein lists are linked forwardly and backwardly, is shown merely for illustrative purposes, as the data repository can be implemented in any suitable manner, as explained above. It should be appreciated that such forward and backward links may be used in connection with any construct (e.g., any nucleic acid and/or polypeptide construct).

The linkage 128 to the located sequence record 124 links the sequence record 124 to a specified rights record 132, which indicates that a commercial license for this sequence is not available. The linkage 128 also links, via a link 134, the sequence record 124 to a suggested vector record 138 (vector xφ10) and, via a link 142, to a special conditions record 146 (no special conditions recorded). The fact that the nucleotide segment 100 is controlled by rights which permit no commercial use may make the nucleotide segment 100 unsuitable for its intended purpose. In such a case, in some embodiments, the search engine 104 can be instructed by the user to search for another nucleotide segment which may be a potential suitable replacement for the nucleotide sequence in question. The determination of a suitable replacement for any particular nucleotide sequence can be determined and searched for in any suitable manner, as the aspects of the present invention that relate to suggesting replacements are not limited to any particular technique for determining or locating suitable replacements. It should be appreciated that the identification of a replacement or substitute building block in connection with any methods or system described herein may be based on sequence information, structural information, functional information, or any combination thereof. For example, segments with similar sequences may be provided. In the case of a protein coding nucleic acid sequences, alternative sequences that encode that same or a related polypeptide sequence may be provided. In some embodiments, one or more related sequence motifs (e.g., from different organisms or species, related to a consensus sequence, etc.) may be provided. In the case of polypeptide sequences, alternative sequences having conserved amino acid substitutions may be provided. If building blocks are defined structurally, alternative building blocks having the same structure (e.g., the same secondary or tertiary structure). If building blocks are defined functionally, alternative building blocks having the same function may be provided. A building block may be defined based on any suitable function. For example, a function may be based on expression (e.g., transcription regulation, translation regulation, product stability, product function—enzymatic function, receptor binding, ligand binding—etc., or any combination thereof).

In one embodiment, the search engine 104 searches for an alternative nucleotide segment based upon the fact that the genetic code is degenerate. In this example, another nucleotide segment 150, which has a guanine residue at the third position from its 5′ end instead of the adenine, would also code for the amino acid proline and potentially is a replacement segment for the desired nucleotide segment 100. The forward and backward links 154 connect the record 150 in the nucleotide list 112 with a record 160 (no ownership) in the rights list 116, via links 158 and 164 to records Is 138 (xφ10) and 168 (X₂₁392) of the vector list 118, respectively. In the example shown in FIG. 3, an additional link 172 to a record 146 (none) in the special conditions list 122 is shown. Thus, it appears that the found nucleotide segment 150 has similar characteristics to the nucleotide segment 100. That is, the same vectors may be used and no special handling conditions are required. The difference between the segments, in addition to the structural differences, is that one nucleotide sequence, 124, is owned and not licensable for commercial use, while another, the nucleotide sequence 150, is not owned and hence is available for use.

The results of the database search can be communicated to the user in any suitable manner. For example, the results may be returned to the terminal 58 for review by the user or printed as a report which, in turn, can be textual, graphical, or in any other suitable form. In addition, criteria can be specified such that the search engine 104 automatically searches for alternatives if any of the rights relating to the desired segments do not match the predetermined criteria.

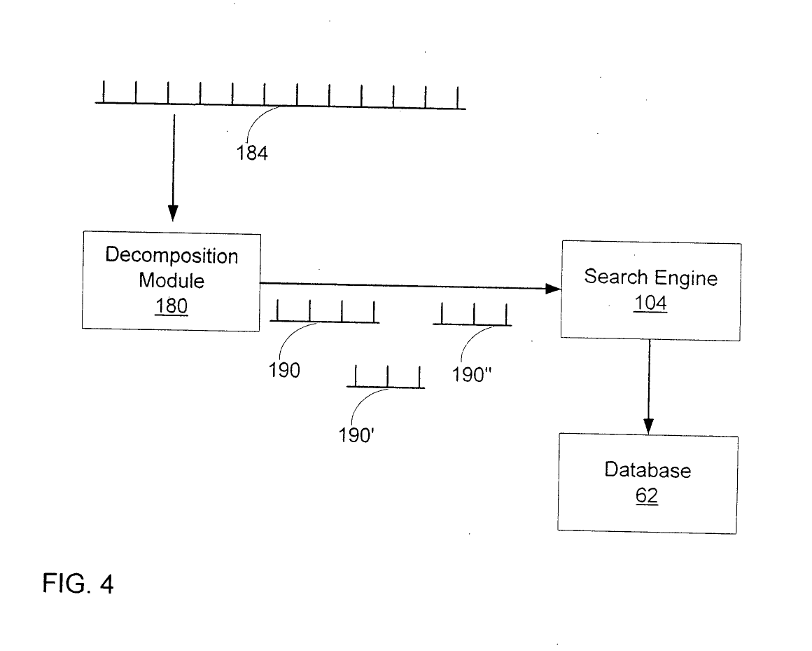

FIG. 4 illustrates an embodiment of the invention comprising a decomposition module 180 which permits the user to enter a desired final construct 184, which is shown, by way of example, as a polynucleotide (e.g., a gene), and the module fragments the construct 184 into a series of building blocks 190, 190′, and 190″. The segments 190, 190′, and 190″ may then be used as an input to the search engine 104 which searches the database 62 for the individual segments as described above in connection with FIG. 3. In some embodiments of the invention, one or more sequences (e.g., nucleic acid and or polypeptide sequences) may be decomposed into smaller sequence segments that are suitable for comparison with the information in the data repository. Accordingly, in some embodiments, the type of information in the data repository may impact the extent of decomposition performed by the decomposition module. The searches performed by a method or system of the invention may be based on sequence similarities with the sequence segments, predicted structural properties of the sequence segments, predicted functional properties of the sequence segments, or any combination thereof.

Although the description discusses exemplary embodiments relating to nucleotide segments, polynucleotides, legal rights, vectors and special conditions, other additional data lists such as promoters, enhancers, plasmids, selection markers, and others may be included or substituted.

Further, it should be understood that embodiments of the invention are not limited to use with nucleotides, but may also be used to design, construct, and test polypeptides, proteins, and molecular tags, to name a few. Accordingly, all examples of methods and/or systems described herein may be applied to any suitable construct (e.g., any nucleic acid or polypeptide construct) unless otherwise indicated.

It also should be appreciated that a construct of the invention may be a single linear polypeptide or polynucleotide polymer. However, in some embodiments, a construct may be a multimer of separate polymer subunits that interact or bind to each other (e.g., a dimer, trimer, tetramer, etc.). A multimer may be a homo-multimer or a hetero-multimer. Accordingly, in some embodiments of the invention, one or more restrictions described herein may specifically apply to rights and or characteristics of multimers and not the individual subunits of the multimers. For example, the user may wish to engineer an immunoglobin-G (IgG) antibody molecule. An IgG molecule is a quatramer constructed of two heavy polypeptide chains and two light polypeptide chains. The two heavy chains are bound together along their carboxyl portion by two disulfide bridges, forming a “Y” shaped structure. The two light chains are bound one to each arm of the “Y” of the heavy chain “Y” structure. The amino end of the quatramer, both of the heavy and light chains, forms the antigen binding site. The antigen binding site has both variable and hypervariable positions in which the amino acids, which make up the chains, vary significantly. It is this variability that permits the molecule to recognize and attach to specific antigens.

Thus, a user may wish to construct an IgG molecule having a specific amino acid sequence in the variable region of the molecule in order to direct the antibody to a specific antigen. The user may specify, for example, a light chain of the molecule, and then determine use restrictions and special conditions required to assemble the complete IgG molecule. Thus, any desired construct that may be assembled from smaller blocks may be checked for ownership and other restrictions that would prevent the construct from being used by its designer and/or made by an entity the designer is designing for. For example, constructs created by combinatorics, such as, for example, domain swapping, may be governed by intellectual property rights or other restrictions as described herein.

In some embodiments, various molecular segments within the database 108 may be linked to other molecular segments within the database 108 by commonality of features. The feature categories may include, for example, source, interoperability with other parts or segments blocks, tertiary structure, functionality, polarity, hydrophobicity, membrane permeability, FDA approval, bioreactivity, safety, toxicity, stability, bioavailability, environmental hazards, isoelectric point, charge, thermostability, melting temperature, annealing temperature, catalytic activity, side groups, topology, kinetic complexity, mRNA secondary structure, other suitable features, and any combination of any of the above. The linking according to common factors can be implemented in any suitable manner. In one embodiment, a series of tables may be defined, one for each feature category, where a unique identifier may be assigned to each of the molecular segments in the database 108. Each feature category table may list the unique identifier for each molecular segment belonging to the feature category. When a feature category is selected by the user, each unique identifier in the table acts as a pointer to the corresponding molecular segments in the database 108. Some of the feature categories may require one or more additional levels of indirection before arriving at the molecular segments list. For example, the category “functionality” may have additional subcategories, such as, for example, “receptor ligand”, “translational promoter”, “nuclease”, etc. If the subcategory “translational promoter” is selected, the table entries might point directly into the molecular segment list, while if the subcategory “nuclease” is selected, additional subcategories, such as “exonuclease” or “endonuclease”, may be required before their table entries point to the molecular segments in the database 108.

Thus, the user, through interaction with the database 108, independently, or via any other suitable means, may choose parts from which to build the construct, hypothesize how the parts will interact, and how the parts will operate in combination. The user inputs or retrieves an identifier piece or the whole building block that the user would like to use in the construct. Alternatively, the sequence of the entire construct may be entered, and the database is queried to identify what use restrictions are associated with the construct. The user thus avoids inadvertently using illegal molecular segments (e.g., DNA) and knows with certainty what rules apply with respect to the molecular segments being considered for inclusion into the construct.

Once the construct is designed, the designer or any other possessing the authority to act on behalf of the construct maker, may be presented with a license to use the components required by the design to make the construct. In some embodiments of the invention, the license may be a single sign-once license that obtains the proper license rights for the designer from all relevant rights holders 36 and 36′. In other embodiments, multiple licenses are generated and entered into (e.g., signed) by the designer 40 or other entity empowered acting on behalf of the construct maker. In this way, the designer 40 can simply pay once to a rights manager in the rights management module 32 for all the rights required to build the construct. In return, the rights manager of the rights management module 32 makes payments to the rights holders 36 and 36′, according to their licensing terms. It should be appreciated that multiple sign-once licenses may be required. For example, it is possible that a separate license may be required for an experimentation process, and a different license may be required for manufacturing. In various embodiments of the invention, it is contemplated that each type of license required a sign-once license.

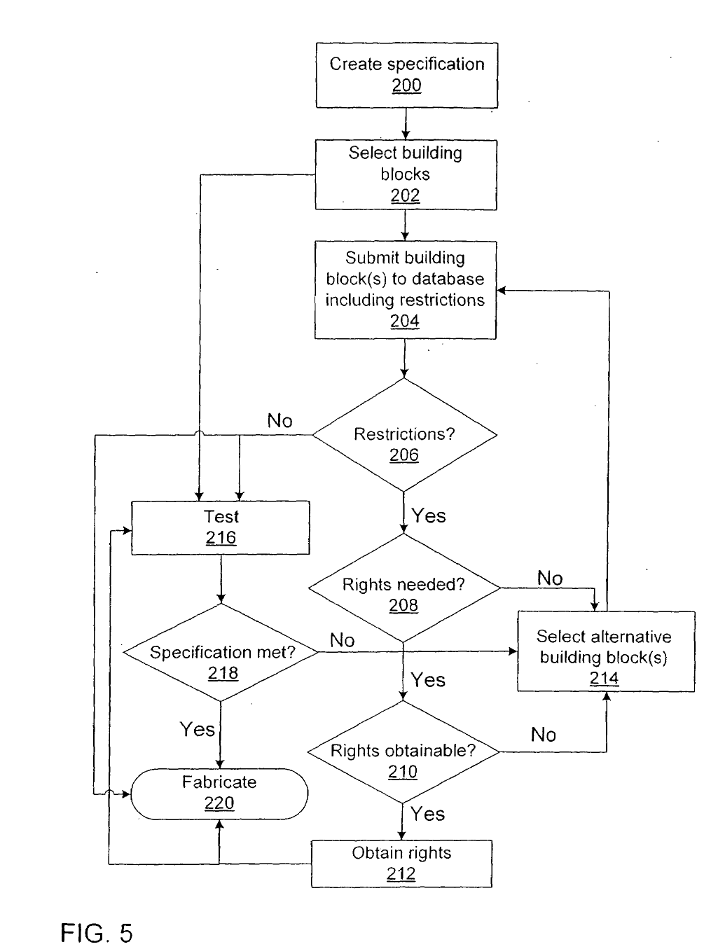

Some embodiments of the invention provide a method for designing, obtaining necessary rights, fabricating and testing the construct. FIG. 5 is a flowchart illustrating schematically one such method. In a step 200, a specification for a construct, construct building blocks, or any suitable combination thereof, is created. The specification may contain requirements for the desired construct and/or construct building blocks.

In a step 202, building blocks that may constitute the desired construct (e.g., polynucleotide or polyprotein) and/or construct building blocks may be selected. It should be appreciated that the building blocks may be selected in any suitable manner, e.g. specified by a designer (or any other user), selected automatically from a data repository or otherwise. It should also be appreciated that the desired construct and/or construct building blocks may be divided into any suitable (smaller) building blocks (e.g., molecular segments), depending on the specification and properties, structure and other features relating to the construct and/or construct building blocks. A decomposing module 180 described above in connection with FIG. 4 may be optionally employed to “decompose” the construct and/or construct building blocks into smaller building blocks. The data repository may be any suitable data storage (e.g., data storage devices 62, 72, and 88) comprising the library of constructs, construct building blocks, any combination of constructs and construct building blocks, use restrictions, and any other information, as discussed above.

The building blocks selected in step 202 may then be tested in a step 216. The test module 28 may be employed at the testing phase. Alternatively, in a step 204, the selected building blocks may be submitted to the data repository (e.g., data storage devices 62, 72, and 88, or other suitable data repositories) that includes, among other information, any suitable restrictions, including use restrictions and one or more features or feature sets related to building blocks. Each building block may be submitted separately, or any number of building blocks in any suitable combination may be submitted simultaneously. The building blocks selected in step 202 may also be submitted in any suitable form (e.g., as a specification, materials, or any other) directly for fabrication in a step 220. The fabrication module 24 or any other suitable facility may be employed.

A search engine may then identify, in step 206, whether any restrictions exist on the building blocks. If the answer is affirmative, in a step 208, it is determined whether any rights (e.g., legal rights) may be needed to use the building blocks, which may be done, for example, by querying the data repository discussed above. If rights are necessary, step 208 proceeds to a step 210, at which it is determined whether the rights are obtainable (e.g., a license may be obtained). If the answer is affirmative, the rights may be obtained in a step 212, which may be realized using the rights management module 32.

The “cleared” construct and/or construct building blocks may be fabricated in step 220. Optionally, the “cleared” construct and/or construct building blocks may be tested in step 216. It should be understood that use of a construct and/or construct building block may be determined to be hindered by both legal restrictions and restrictions related to certain functional, structural, or other features (e.g., a protein may cause toxic cell injury) related to the construct and/or construct building blocks. In this case, the design process may proceed towards selecting alternative block(s) in step 214 and, optionally, via step 210, towards obtaining rights in step 212.

If step 210 determines that the rights cannot be obtained, one or more alternative building blocks may be selected, in a step 214. It should be appreciated that the design, testing and fabrication modules may function interchangeably and that the described method may use these modules any suitable number of times and in any suitable order. In addition, other modules may be implemented as part of the system according to embodiments of the invention.

If it is determined in step 208 that no rights are needed, the process determines that existing restrictions identified in step 206 are related to some functional or structural properties or other features of one or more building blocks and proceeds to step 214 where one or more alternative building blocks may be selected. As discussed above, the step of searching for suitable alternative building blocks may be chosen to be performed automatically. If no restrictions were identified in step 206, the construct and/or construct building blocks may be tested in any desired way in step 216.

At any time during the testing phase or upon the completion of the testing phase, in a step 218, it may be determined whether the construct and/or construct building blocks meet the requirements specified in the specification created in step 200. If the requirements are determined to be met, the tested construct and/or construct building blocks may be fabricated, in step 220. The fabrication may also be conducted at an outside facility.

Thus, some embodiments of the invention provide capabilities to design and/or modify a design, obtain necessary rights, fabricate, and test a construct (e.g., a nucleic acid or other nucleotide polymer or a protein or other amino acid polymer). With all these capabilities provided by a single entity, the result is a one-stop facility that can be used to create incentives for designers to proceed from the acquisition of rights into an associated design/fabrication/testing facility by offering reduced fees and the ability to reduce the design-fabrication-testing cycle. It is possible for some constructs, such as a cell, to self-test after fabrication.

This method of conducting a construct designing business provides a business model which not only accrues to the benefits of the design/fabrication/testing facility but also to the designer by providing a system and method by which the designer can reduce the development time for each construct. The designer may also reduce this latency while making sure that the rights necessary to make the construct reside with the designer. It should be appreciated that although the example above described the rights library as containing the rights of third party rights holders, that the rights library alternatively may contain no proprietary construct components; proprietary components from only the owner of the design/fabrication/testing facility; collaborative third party rights; building blocks licensed from third parties and granted on a sublicense basis; and/or any other rights. The database may also comprise annotations in addition to rights and specifications associated with a building block, such as, for example, literature references, attributions, publications, patent references, purchasing information, and/or ordering capabilities.

Some embodiments of the invention enable the user to inform himself of often conflicting third party private or governmentally imposed legal use restrictions inuring to construct building blocks, and to select a functionally operative and legally permissible set of building blocks as candidates for inclusion in the design. This can be done prospectively during the design of the construct, by making inquiries about respective building blocks under consideration. This can also be done retrospectively upon completion of the design phase, by way of an audit or post design assessment of the designed construct and any of its building components. The system may also provide a mechanism through which standards of safety can be publicized and implemented, and third party patent rights and the like can be respected and enforced. Some embodiments of the invention may also provide a centralized, accessible source of data which enables users to make rational function-based decisions among design alternatives. Thus, embodiments of the invention provide a system that can be considered as a clearinghouse for clearing constructs and construct building blocks for use.

Embodiments of the invention may assist scientists, engineers and any other users engaged in the continuing elucidation of molecular biology mechanisms and in the creation and discovery of new and useful biological parts. Embodiments of the invention are directed to enabling diverse users to deposit voluntarily their discoveries and creations, or the sequence information defining them, with a data repository included in the system according to embodiments of the invention. The system may potentially act as a distributor to interested users. The users could specify the structure, sequence, use restrictions, royalty loads, compatibility data, functional data, and/or any other suitable information relating to created or discovered constructs or construct building blocks. As an example, an intellectual property control mechanism may be provided for a scientist who, for example, discovers and patents a new fluorescent protein that can be used as a marker of a successful DNA transfection. The scientist or any other agent authorized to act on his behalf may submit the sequence of the new buipart to the system according to embodiments of the invention, possibly also depositing samples, and providing descriptive data, use data, and/or specifications for the new protein. At the same time, use restrictions on the new protein may be submitted to the system repository by the designer of the protein or a corresponding authority (e.g., a university). The use restrictions might specify, for example, that the protein is freely available for academic or non-profit research, draws a $2.00 royalty per use for profit-based research, a royalty of 10% per unit if sold as a separate consumable reagent into the biological reagent market, and a royalty of 5% per unit incorporated in a kit or package off reagents and sold into the biological reagent market. Enforcement of royalty payments may be imposed in any suitable manner, examples of which are discussed above.

Once the construct is created, a therapeutic or diagnostic may be made utilizing the construct. The designer and the design/fabrication/testing facility owner and/or the rights owners can collaboratively market the therapeutic or diagnostic and divide the revenue thereby obtained.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device. Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or conventional programming or scripting tools, and also may be compiled as executable machine language code or intermediate code that is executed on a framework or virtual machine.

In this respect, the invention may be embodied as a computer readable medium (or multiple computer readable media) (e.g., a computer memory, one or more floppy discs, compact discs, optical discs, magnetic tapes, flash memories, circuit configurations in Field Programmable Gate Arrays or other semiconductor devices, etc.) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Having thus described several embodiments of this invention, it is to be appreciated that various alterations, modifications, and improvements will readily occur to those skilled in the art. Such alterations, modifications, and improvements are intended to be within the spirit and scope of the invention. Accordingly, the foregoing description and drawings are by way of example only.

What we claim is:

1-49. (canceled)

50. A method for building a construct comprising the steps of:
defining a molecular structure for use as a subpart in the construct; and
searching a database comprising a plurality of molecular structures and a plurality of rights, each right of said plurality of rights associated with at least one of said plurality of molecular structures, for rights associated with said defined molecular structure.

51. The method of claim 50 further comprising the step of displaying said rights associated with said defined molecular structure.

52. The method of claim 50 wherein said construct comprises a polynucleotide and said molecular structure comprises an oligonucleotide, said construct comprises a multigenic assembly of DNA and said molecular structure comprises a smaller polynucleotide or an oligonucleotide, or said construct comprises a cell and said molecular segment comprises a multigenic assembly of DNA, a smaller polynucleotide, or an oligonucleotide.

53. The method of claim 50 further comprising the step of defining the construct.

54. The method of claim 50 further comprising the step of decomposing said construct into a plurality of molecular structure.

55. The method of claim 50 further comprising the step of identifying an alternate molecular structure if the rights associated with said defined molecular structure do not reach a predetermined level of rights.

56. The method of claim 50 wherein the rights in the database are selected from a group
consisting of patent restrictions, functional restrictions, transfer restrictions, commercialization restrictions and field of use restrictions.

57. The method of claim 50 wherein the database further comprises a plurality of vectors.

58. The method of claim 50 wherein said construct is a polypeptide and the molecular structure is a polypeptide subunit.

59. The method of claim 50 wherein said database is maintained in association with a biological parts repository comprising the additional step of:
purchasing selected molecular structures through said repository.

60. The method of claim 59 comprising the additional step of virtually constructing and simulating operation of said construct.

61. A system for clearing the use of molecular segments in a construct comprising:
a molecular segment module defining a molecular segment for use in the construct;
a database comprising a plurality of molecular segments and a plurality of rights, each right of said plurality of rights associated with at least one of said plurality of molecular segments; and
a database manager for searching said database for said defined molecular segment.

62. The system of claim 61 further comprising a display displaying rights associated with said defined molecular segment in response to said search of said database.

63. The system of claim 61 wherein said construct comprises a polynucleotide and said
molecular segment comprises an oligonucleotide.

64. The system of claim 61 further comprising a construct decomposer for decomposing said construct into a plurality of molecular segments.

65. The system of claim 61 further comprising a molecular segment identifier identifying an alternate molecular segment if the rights associated with said defined molecular segment do not reach a predetermined level of rights.

66-91. (canceled)
